(19) United States
(12) Patent Application Publication
(10) Pub. No.: US 2010/0314482 A1
(43) Pub. Date: Dec. 16, 2010

(54) ROLLED TURF LAYER

(76) Inventor: Eric Merkt, Athens, AL (US)

Correspondence Address: NEXSEN PRUET, LLC, P.O. BOX 10648, GREENVILLE, SC, 29603, US

(21) Appl. No.: 12/446,011

(22) PCT Filed: Nov. 19, 2007
(86) PCT No.: PCT/US07/85121

§ 371 Date: Apr. 17, 2009

Related U.S. Application Data
(60) Provisional application No. 60/859,650, filed on Nov. 17, 2006.

(51) Int. Cl. B65H 16/06; A01B 45/00; A01G 1/12

(52) U.S. Cl. 242/557

(57) ABSTRACT

A rolled turf layer including a main frame tube supported by a frame assembly adapted for installation on a three point hitch of a vehicle such as a tractor. A pair of slides or extension members are slidably mounted in the main frame tube with outer ends extending in opposite direction therefrom. A pair of rearward extending outside frame arms are rigidly secured to the outer ends of the extension members. Each frame arm rotatably supports a cone shaft carrying an inward facing turf roller insert adapted for insertion into the interior center of a turf roll. Each turf roller insert is rigidly secured its supporting cone shaft which extends through bearings in the associated outside frame arm. The left and right turf roll inserts are inward facing and opposite each other. An electrically actuated brake assembly is mounted on one frame arm and is operated by a control on the supporting vehicle. Manually operated controls are also provided for solenoid valves controlling operation of the left and right hydraulic cylinders within the main frame tube by which the laterally spacing of the left and right frame arms is adjusted.

### BACKGROUND OF THE INVENTION

The present invention relates generally to turf or turf installation devices and more specifically to a device for laying rolled turf. Modern landscaping techniques rely upon the installation of large rolls of turf. Turf is used for carpeting golf courses, covering athletic fields, and covering business or home lawns. Laying harvested turf offers a quick alternative to seeding and is frequently used to provide new lawns and landscape for new construction or overhaul of previous existing facilities. A large portion of the expense of a new lawn or field created with palletized square turf can usually be attributed to installation costs. This is largely the result of an inherently labor intensive turf laying process. Each piece of turf on a pallet is heavy and unwieldy and large installation areas require numerous pallets of turf with laborers placing each piece of turf individually.

Various turf forming, harvesting and installation methods have been developed in response to the disadvantages of hand laying turf. One method is to harvest the turf in large rolls. These turf rolls can be installed on a ground surface by unrolling the turf roll as the turf roll is displaced along the ground surface. These bulky turf rolls are very heavy and generally require the use of machinery to transport and unroll them upon the ground surface. Current machinery includes manual devices mounted to a tractor three point hitch. An elongated rod must be manually inserted through the center of a turf roll and then manually attached to the rolling device. Since the time required for installing the turf roll onto a tractor is a significant portion of the total time to install the turf roll upon the ground surface, this method frequently requires a dedicated laborer to assist the tractor operator in installing the turf roll on the tractor. This method then has added labor cost and safety issues related to a dismounted laborer working around a tractor or other vehicle. Finally, current devices to install the turf roll in the rolling device can not pick up rolls on non-level ground surfaces.

What is needed is a device that can be readily mounted on a tractor and can be operated by the tractor operator to pick up and unroll a large turf roll without the need for other assistance. What is also needed, is a device that can be readily mounted on a tractor and can be operated by the tractor operator to pickup and unroll a large turf roll on uneven ground.

### BRIEF SUMMARY OF THE INVENTION

A preferred embodiment of the present invention is a rolled turf layer including a main frame tube supported by a frame assembly adapted for installation on a three point hitch of a vehicle such as a tractor. Inside slides are slidably disposed in bores, which are themselves disposed in left and right ends of the main frame tube. Each inside slide is affixed to a forward end of a rearward extending outside frame arm. Each of the right and left outside frame arm carries an inward facing turf roller insert adapted for insertion into the interior center of a turf roll. Each turf roller insert includes a turf insert cylinder having a turf stop disk on one of its ends and a turf insert cone attached on its opposite end. Each turf roll insert is axially mounted on and secured to a cone shaft which extends through the outside frame arm. The left and right turf roll inserts are inward facing, aligned and oppose each other. A power operated brake assembly is mounted on one tube shaft and is operated by a remote control on the vehicle supporting the rolled turf layer. The brake may be hydraulically operated, however an electrically powered brake is preferred. A pair of aligned hydraulic cylinders are used to selectably extend or retract the left or the right frame arms through operation of solenoid valves controlled by a joy stick.

Advantageously, with the rolled turf layer of the preferred embodiment installed upon a tractor, the tractor operator may approach a turf roll and manipulate the rearward extending frame arms either in tandem or independently to insert one or both turf roll inserts into the center of the turf roll and thereby install the turf roll in the rolled turf layer without any assistance. This novel feature saves time and eliminates significant labor cost.

The rolled turf layer of the present invention is adapted to overcome a prior art problem of installing a turf roll disposed on uneven ground by means of independent manipulation of one frame arm to raise the lower end of the turf roll until the turf roll is level and the opposing frame arm is manipulated to engage the upper end of the turf roll.

With a roll of turf mounted in the rolled turf layer of the present invention between the opposing turf roll inserts, the turf roll is unraveled as the tractor moves the rolled turf layer forward. Advantageously, if the turf roll begins to slough so as to form ridges and visible air pockets in the installed turf, the tractor operator may apply braking force sufficient to place tension on the unraveled portion of turf and to slide the unraveled portion of turf across the ground substrate so as to remove the ridges and visible air pockets. This feature saves time and eliminates significant labor cost to repair turf ridges that prior art turf layers frequently produce during installation of rolled turf.

### BRIEF DESCRIPTION OF THE DRAWINGS

The invention is illustrated in the drawings, in which:

FIG. 1 is a perspective of one embodiment of a turf roll installing device of the present invention;

FIG. 2 is a rear view of the apparatus of FIG. 1 with parts broken away to show part of the control apparatus;

FIG. 3 is a top view of the apparatus of FIGS. 1 and 2;

FIG. 4 is a right side view of the apparatus of FIG. 3, and

FIG. 5 is a view of the operator controls for the rolled turf layer;

FIG. 6 is a perspective of an embodiment of the rolled turf roller supported on a vehicle mounted three point hitch, and

FIG. 7 is a schematic showing a control system for the rolled turf layer.

### DETAILED DESCRIPTION OF THE INVENTION

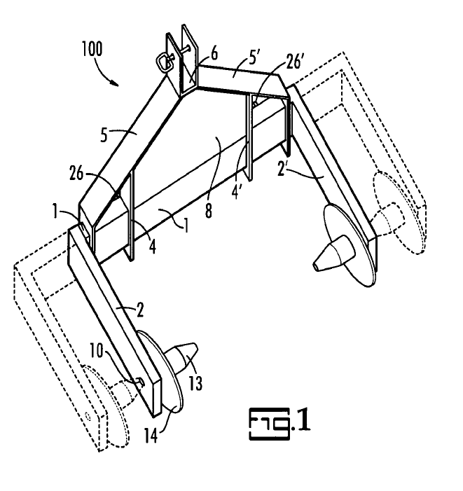

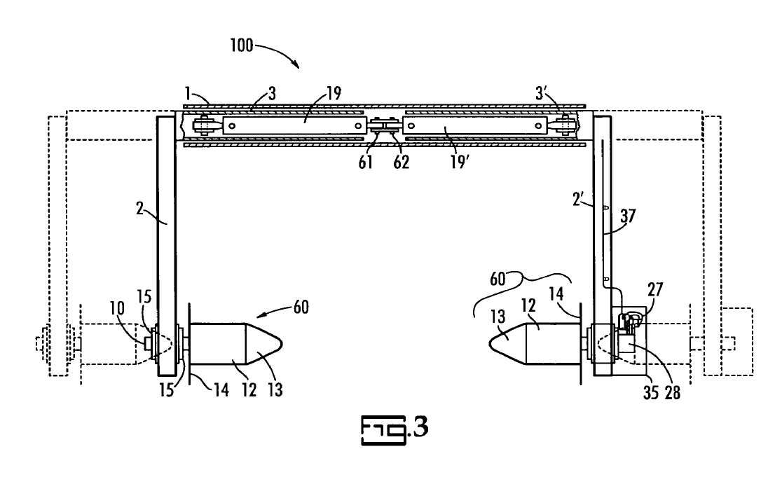

The rolled turf layer 100 shown in FIG. 1 includes left and right frame supports 5, 5′ separated by a U-shaped frame support spacer 6 and having left and right frame braces 4, 4′ attached to the respective frame supports 5, 5′. Frame braces 4, 4′ and frame supports 5, 5′ are all attached at separate points to a horizontal main frame tube 1 as shown. Implement pins 26, 26′ are mounted on each left and right frame braces 4, 4′ so as to form a lower pair of mounting points for a three point hitch. Front and rear frame covers 7 and 8 are additionally attached to the main frame tube 1 and the frame supports 5, 5′ to form a chamber for solenoid control valves. As shown in FIG. 3, the main frame tube 1 has an interior bore and, within the left and right ends thereof, frame arm slides 3, 3′ are disposed so as to slide laterally within the bore.

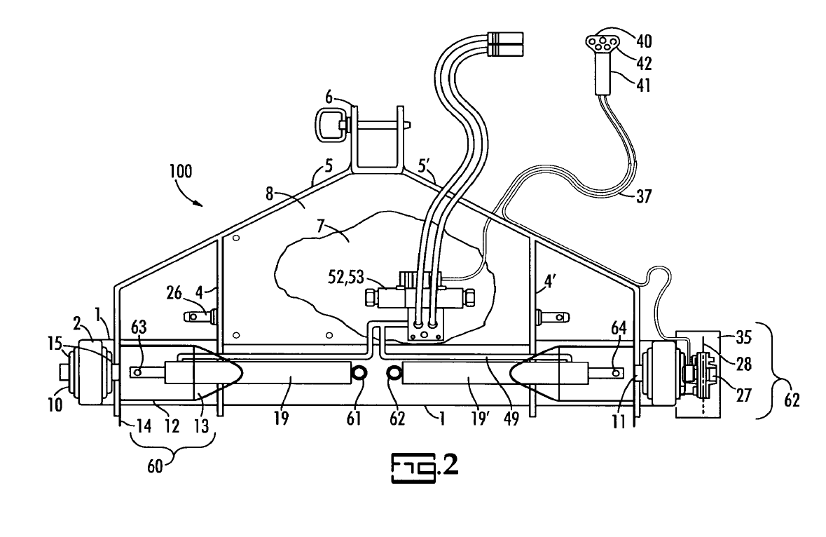

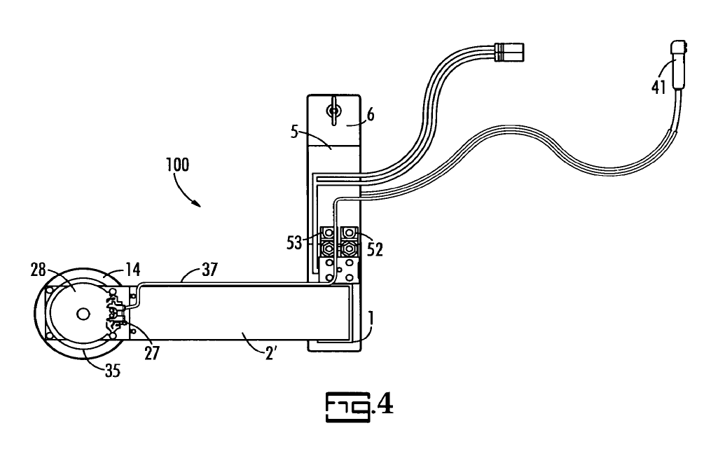

Referring also to FIGS. 2, 3 and 4, rearward extending outside frame arms 2, 2′ are attached to each left and right slides 3, 3′ and are extended by operation of hydraulic cylinders 19, 19′, respectively, which are controlled by solenoid valves 52, 53. Each outside frame arms 2, 2′ carries on its rear or distal portion an inward facing turf roller insert 60, which is adapted for insertion into the interior center of a turf roll. Each turf roller insert 60 includes a turf insert cone 13 which is attached to one end of a turf insert cylinder 12. A turf stop disk 14 is attached to the other end of the turf insert cylinder 12 so as to prevent the turf roll from contacting the frame arms 2, 2′. The left and right turf roll inserts 60 are rigidly secured to a cone shafts 10 and 11, respectively, which extend through the respective outside frame arms 2, 2′ and are each supported by a bearing 15. The left and right turf roll inserts 60 are inward facing, horizontally aligned, and oppose each other. The left and right frame arms 2, 2′ may be extended in unison and retracted in unison beyond the left and right ends of the main frame tube 1, or the frame arms 2, 2′ may be individually extended and retracted.

The preferred embodiment of the invention includes a braking device to slow or stop rotation of the turf roll during laying operations. The braking system for the present invention may be selected from known braking systems, such as mechanically actuated brakes, hydraulically actuated brakes and electrically actuated brakes. In the preferred embodiment shown in the drawings, an electric brake assembly 62 is mounted on a tube shaft 11 rigidly secured to and supporting a turf roll insert 60. The electric brake assembly 62 includes a brake rotor cover 35, which covers the brake rotor and hub 28 and the caliper assembly 27. The electric brake 62 is operated by an operator by means of a switch 30 at the joy stick panel 42 of the joy stick 41 which slows or stops rotation of the tube shaft 11.

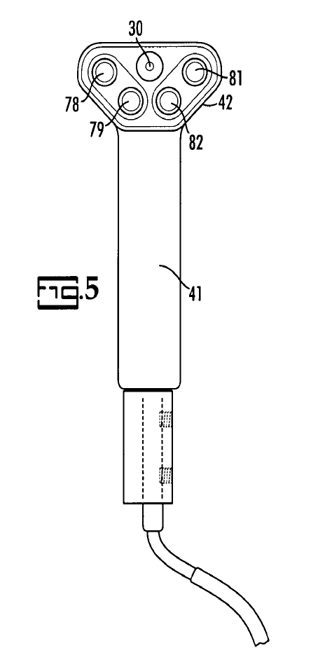

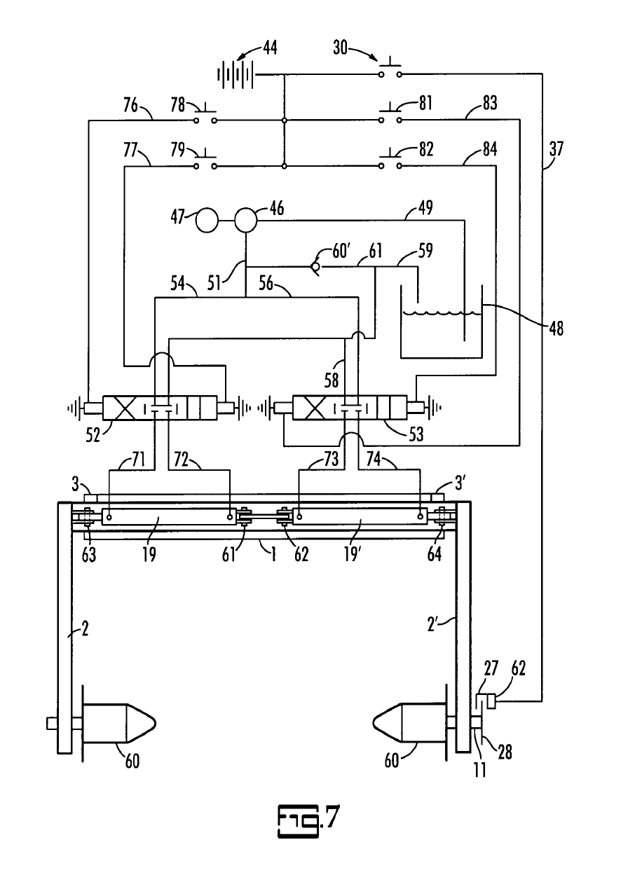

The preferred embodiment of the invention includes a fluid or hydraulic actuation system to control the operation of the left and right hydraulic cylinders 19, 19′. The control system of the present invention is selectable from suitable fluid control systems, including mechanically operated fluid control valves, pneumatically or hydraulically operated hydraulic control valves and electronically actuated hydraulic valves. Referring to FIGS. 5 and 7, the turf roll layer 100 has a control system which includes a joy stick 41 at the operator's station on the three point hitch vehicle to which the turf roll layer is attached. As shown in FIG. 7, a suitable electric power source 44 is connected by a lead 37 to the electric brake 62. A fluid pump 46 is driven by a power source 47 such as the vehicle engine or an electric motor and includes an intake connected to a reservoir 48 by conduit 49. The pump discharge is connected to an output conduit 51 which in turn is connected to solenoid valves 52, 53 by branch conduits 54. 56. The solenoid valves 52, 53 are connected to the reservoir 48 by return conduits 57, 58, 59. A high pressure relief valve 60 is included in a relief conduit 61 interconnected between the pump output conduit 51 and the return to reservoir conduit 59. As illustrated, the solenoid valves 52, 53 are in their hold position in which delivery conduits 54 and 56 are connected to the return to reservoir conduit 59 via leads 57, 58 and delivery of fluid to and return of fluid from the linear actuators or fluid cylinders 19, 19′ is prevented. The cylinder components of the linear actuators 19, 19′ are pivotally connected to the main frame tube 1 by pins 61, 62, respectively, and the rod components of the linear actuators 19, 19′ are pivotally connected to the arm assemblies 2, 2′ by pins 63, 64, respectively. The fluid actuator 19 is connected to the solenoid spool valve 52 by conduits 71, 72 and the fluid actuator 19′ is connected to the solenoid spool valve 53 by conduits 73, 74. As shown in FIG. 5, a pedestal 41 with a control panel 42 at the operators station on the supporting vehicle allows the tractor operator to control operation of the solenoid valves 52, 53 and the electric brake 62. Referring also to FIG. 7, electric leads 76, 77 extend between the source of electricity 44 and the solenoid valve 52. Switches 78, 79 in leads 76, 77 which are located at the joy stick control panel 42, control operation of the solenoid valve 52 and movement of the frame arm 2. Switches 81, 82 at the control panel 42 in leads 83, 84 control operation of the solenoid valve 53 and movement of frame arm 2′. Thus the operator can individually adjust the position of arms 2, 2′.

With the rolled turf layer of the preferred embodiment shown in drawings installed upon a tractor via a three point, the tractor operator may approach a turf roll and manipulate the rearward extending frame arms 2 either in tandem or independently as desired to insert one or both turf roll inserts 60 into the center of the turf roll. This novel feature saves time and eliminates significant labor cost to install rolled turf in the rolled turf layer as compared to known prior art rolled turf layers which required a second laborer to install a lifting rod into the turf roll and attach the lifting rod to a lifting frame of the prior art.

Where the turf roll is initially disposed on uneven ground, the lower end of the turf roll may be raised by manipulation of one of the frame arms 2, 2′ to insert a turf roll insert 60 independent of the opposing frame arm 2 and its turf roll insert 60. Once a turf roll insert 20 is inserted in the lower end of the turf roll, that end may be raised until the turf roll is level. Then the opposing frame arm 2 is manipulated to insert its turf roll insert 60 into the upper end of the turf roll. This novel feature overcomes a long standing problem of mounting rolled turf from an uneven surface. Prior art devices required dragging or lifting the rolled turf manually or by means of a fork lift to a level position or a level ground surface.

With a roll of turf mounted in the rolled turf layer between the opposing turf roll inserts 60, the free end of rolled turf is positioned at the desired starting point on a ground substrate. The turf roll inserts 60 and their shafts rotate in their bearings and the turf roll is unraveled as the tractor moves the rolled turf layer forward over the ground substrate. Advantageously, if the turf roll begins to slough so as to form ridges and visible air pockets in the installed turf, the tractor operator may, apply braking force sufficient to place tension on the unraveled turf and slide the unraveled turf across the ground substrate so as to remove the ridges and visible air pockets. This feature saves time and eliminates significant labor cost to repair turf ridges that prior art turf layers frequently produce during installation of rolled turf. One alternate embodiment of the apparatus and method of operation of the present invention provides for operating the rolled turf layer with the brake partially applied so as to slow the rotation of the turf roll and thereby maintain the unraveled turf under sufficient tension as necessary to prevent sloughing, ridge formation and the creating of visible air pockets.

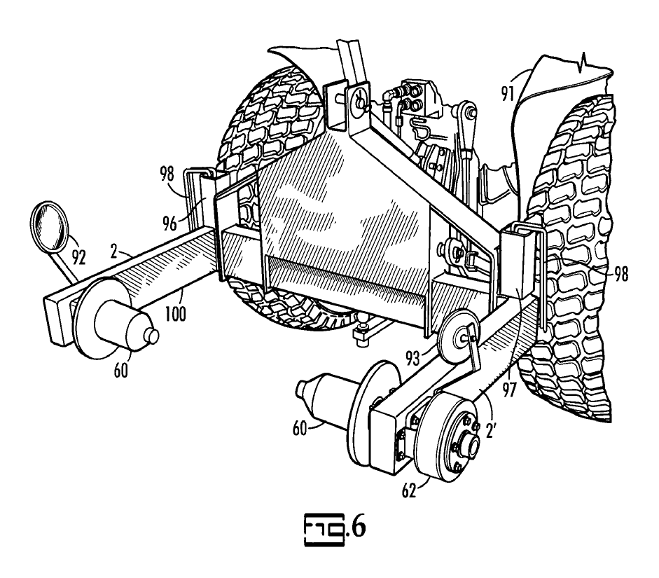

FIG. 6 shows the turf layer 100 mounted by a three point hitch to the rear of a wheeled support vehicle 91. A pair of mirrors 92, 93 are mounted on the frame arms 2, 2′, respectively. The mirrors 92, 93 help the operator in aligning the turf roll inserts 60 with the center opening in turf roll. A pair of turf staple hangers 96, 97, shaped as square section tube segments, are rigidly secured to the frame supports 5; 5′. The staple hangers provided a convenient place to temporarily store the removed turf staples 98 and preserve them for repeated use.

Thus, although there have been described particular embodiments of the present invention of a new and useful rolled turf layer, it is not intended that such references be construed as limitations upon the scope of this invention except as set forth in the following claims.

What is claimed is:

1. A turf layer comprising:
a horizontally extending tube supported by a frame assembly adapted for installation on a three point hitch of the towing vehicle, the tube extending laterally and having left and right bores disposed in the laterally opposite ends thereof;
a first and second extension members slidably disposed in said left and right bores, respectively,
a first and second rearward extending frame arms rigidly secured at their respective forward ends to the laterally outer ends of said first and second extension members, respectively,
a pair of aligned turf roller shafts rotatably supported on a horizontal axis by the rear ends, respectively, of said frame arms and having confronting portions extending laterally inward toward one another,
a pair of turf roller inserts rigidly secured, respectively, to said confronting portions of said shafts, each of said turf roller insert having
a cylindrical portion concentric with its associated shaft,
a cone coaxially secured to one end of said cylinder portion, and
a turf stop disk coaxially secured to cylindrical portion, said cones being in axially spaced confronting relation to one another,
a linear fluid actuator interposed between said tube and each of said arms, said actuators being operable to extend and retract said arms, laterally,
a power brake assembly mounted on one of said arms in braking relation to the associated turf roller shaft,
a manually operated control for operating said power brake assembly, and
a source of pressurized fluid,
a source of electric power, and
a fluid control system interposed between said source of pressure fluid and said fluid actuators including a pair of solenoid valves operatively associated with said fluid actuators, said source of pressure fluid, and said source of electricity and manually operated switches controlling extension and contraction of said fluid actuators.

2. The turf layer of claim 1 wherein said power brake is electrically powered.

3. The turf layer of claim 2 including a joy stick having manually operated controls for said brake and solenoid valves.

4. The turf layer of claim 1 wherein said fluid control system provides independent operation of said fluid actuators.

5. The turf layer of claim 1 wherein said frame assembly includes a chamber above said tube in which said solenoid valves are disposed.

6. The turf layer of claim 1 having a mirror mounted on each of said frame arms permitting a vehicle operator to view the alignment of the turf roller inserts with a turf roll.

7. The turf layer of claim 1 having a turf staple hanger on said frame assembly.

8. A turf layer comprising:
a horizontally extending tube supported by a frame assembly adapted for installation on a three point hitch of the towing vehicle, the tube extending laterally and having left and right bores disposed in the laterally opposite ends thereof;
a first and second extension members slidably disposed in said left and right bores, respectively,
a first and second rearward extending frame arms rigidly secured at their respective forward ends to the laterally outer ends of said first and second extension members, respectively,
a pair of aligned turf roller shafts rotatably supported on a horizontal axis by the rear ends, respectively, of said frame arms and having confronting portions extending laterally inward toward one another,
a pair of turf roller inserts rigidly secured, respectively, to said confronting portions of said shafts, each of said turf roller insert having
a cylindrical portion concentric with its associated shaft,
a cone coaxially secured to one end of said cylinder portion, and
a turf stop disk coaxially secured to cylindrical portion, said cones being in axially spaced confronting relation to one another,
a powered linear actuator interposed between said tube and each of said arms, said actuators being operable to extend and retract said arms, laterally,
a power operated brake assembly mounted on one of said arms in braking relation to the associated turf roller shaft,
a manually operated control for causing operation of said power operated brake assembly, and
a source of power, and
a fluid control system interposed between said source of power and said actuators, and
manually operated controls controlling extension and contraction of said fluid actuators.
